(19) United States
(12) Patent Application Publication
(10) Pub. No.: US 2009/0144611 A1
(43) Pub. Date: Jun. 4, 2009

(54) ROLE-BASED XML+ CREATION TOOL

(75) Inventors: Michael L. Rohan, Greenwood Village, CO (US); Emily Huang, Denver, CO (US)

Correspondence Address: MICHAEL A DESANCTIS;HAMILTON DESANCTIS & CHA LLP, FINANCIAL PLAZA AT UNION SQUARE, 225 UNION BOULEVARD, SUITE 305, LAKEWOOD, CO, 80228, US

(73) Assignee: RIVET SOFTWARE, INC. A Delaware Corporation

(21) Appl. No.: 12/247,560

(22) Filed: Oct. 8, 2008

Related U.S. Application Data
(60) Provisional application No. 60/978,227, filed on Oct. 8, 2007.

(51) Int. Cl. G06F 17/00

(52) U.S. Cl. 715/234

(57) ABSTRACT

Methods and systems are provided for facilitating the creation of XML+ by presenting functionality and interfaces that clearly separate business and accounting logic from the technical specifications of the underlying language or standard.

### CROSS-REFERENCE TO RELATED APPLICATIONS

This application claims the benefit of U.S. Provisional Patent Application No. 60/978,227, filed Oct. 8, 2007, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2007-2008 Rivet Software, Inc.

### BACKGROUND

1. Field

Embodiments of the present invention generally relate to translating or converting business documents, such as financial statements and/or mutual fund prospectuses, into a standardized, tagged format, such as the extensible Business Reporting Language (XBRL), suitable for data processing and, in particular to an XBRL creation tool that presents a user with different functionality and a specialized user interface based on the user's role, e.g., technical analyst, document preparer, document reviewer, etc.

2. Description of Related Art

XBRL provides a standard for allowing business data to be exchanged among different computer systems and software applications. XBRL is based upon the extensible Markup Language (XML) and has been developed by a consortium of companies and organizations worldwide (such as accounting firms, trade organizations, software vendors, financial institutions and governments). XBRL provides a basis for users to “tag” or “mark up” data within business documents with standardized classifications or definitions which span a multitude of industry reporting and accounting standards and allow a variety of software applications to understand the meaning and context of the information. As just one example of the use of XBRL, the United States Securities and Exchange Commission (SEC) has recently begun a pilot program in which the filing of SEC reports in XBRL is encouraged.

As summarized on the XBRL International website:

“The idea behind XBRL is simple. Instead of treating business information as a block of text—as in a standard internet page or a printed document—it provides an identifying tag for each individual item of data. This is computer readable. For example, company net profit has its own unique tag.

The introduction of XBRL tags enables automated processing of business information by computer software, cutting out laborious and costly processes of manual re-entry and comparison. Computers can treat XBRL data ‘intelligently’: they can recognize the information in a XBRL document, select it, analyze it, store it, exchange it with other computers and present it automatically in a variety of ways for users. XBRL greatly increases the speed of handling of financial data, reduces the chance of error and permits automatic checking of information.

Companies can use XBRL to save costs and streamline their processes for collecting and reporting financial information. Consumers of financial data, including investors, analysts, financial institutions and regulators, can receive, find, compare and analyze data much more rapidly and efficiently if it is in XBRL format.

XBRL can handle data in different languages and accounting standards. It can flexibly be adapted to meet different requirements and uses. Data can be transformed into XBRL by suitable mapping tools or it can be generated in XBRL by appropriate software.”

While the foregoing quote from the XBRL Web-site notes a number of benefits associated with the association of XBRL attributes with data in a business document (which is also known as “tagging”), the accountants and other individuals that generate the business documents for which XBRL tagging is appropriate typically have to associate tagging information with data in their business documents via text/XML editing tools, such as “Microsoft Notepad,” or by using complex XBRL-based stand-alone applications that require user to copy/paste, re-key or import data before being able to convert to XBRL.

Consequently, there is a need for tools that allow individuals that generate business documents to associate XBRL attributes with data or locations in their documents that avoids the tagging of information manually via tools like text/XML editors or by using XBRL-based stand-alone applications that are typically difficult for many of the individuals that generate business documents to learn and/or use.

### SUMMARY

Methods and systems are described for facilitating the creation of XML+ by presenting functionality and interfaces that clearly separate business and accounting logic from the technical specifications of the underlying language or standard.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram of a computer environment in which various embodiments of the present invention may be employed.

### DETAILED DESCRIPTION

Systems and methods are described for facilitating the creation of XML+ by presenting functionality and interfaces that clearly separate business and accounting logic from the technical specifications of the underlying language or standard. According to various embodiments of the Rivet™ CrossTag™ XBRL creation tool as described in the Appendices of the aforementioned provisional patent application, financial data may be easily and intuitively transformed into industry standard XBRL documents, alleviating various of the complexities normally associated with the process. In one embodiment, a web-based, collaborative tagging solution is provided that shields preparers from the complexity of XBRL.

In the Appendices attached to the aforementioned provisional patent application, Genesis was the working name for a software application that addresses the difficulty that non-technical business and accounting users have with translating or converting business documents (such as financial statements or mutual fund prospectuses) into a standardized, tagged format suitable for data processing. Many business documents must be converted to a standardized format such as XML (Extensible Markup Language) and XBRL (Extensible Business Reporting Language), or similar standards. XBRL and several other standards are based on XML, but add specific elements and structure to accommodate a specific need. XBRL, for example is focused on financial and business reporting and Genesis can convert a financial statement (including notes and management comments) into an XBRL Instance Document for filing with a regulatory agency such as the SEC, COREP, taxing authority, or stock exchanges. (RIVET and CROSSTAG are trademarks of Rivet Software, Inc. of Englewood, Colo.).

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, various embodiments of the present invention may be described with reference to the XBRL standard, the concepts discussed herein are designed for use with XML (or similar tagging systems) and all related standards focused on business, finance, or accounting. When referring to XML, XBRL, and related systems, this document and the attached Appendices use the term “XML+”.

For the sake of illustration, various embodiments of the present invention are described herein in the context of computer programs, physical components, and logical interactions within modem computer networks. Importantly, while these embodiments describe various aspects of the invention in relation to modern computer networks and programs, the method and apparatus described herein are equally applicable to other systems, devices, and networks as one skilled in the art will appreciate. As such, the illustrated applications of the embodiments of the present invention are not meant to be limiting, but instead exemplary.

### Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be couple directly, or via one or more intermediary media or devices. As another example, devices may be coupled in such a way that information can be passed there between, while not sharing any physical connection on with another. Based on the disclosure provided herein, one of ordinary skill in the art will appreciate a variety of ways in which connection or coupling exists in accordance with the aforementioned definition.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The term “responsive” includes completely or partially responsive.

### Exemplary Computer System Overview

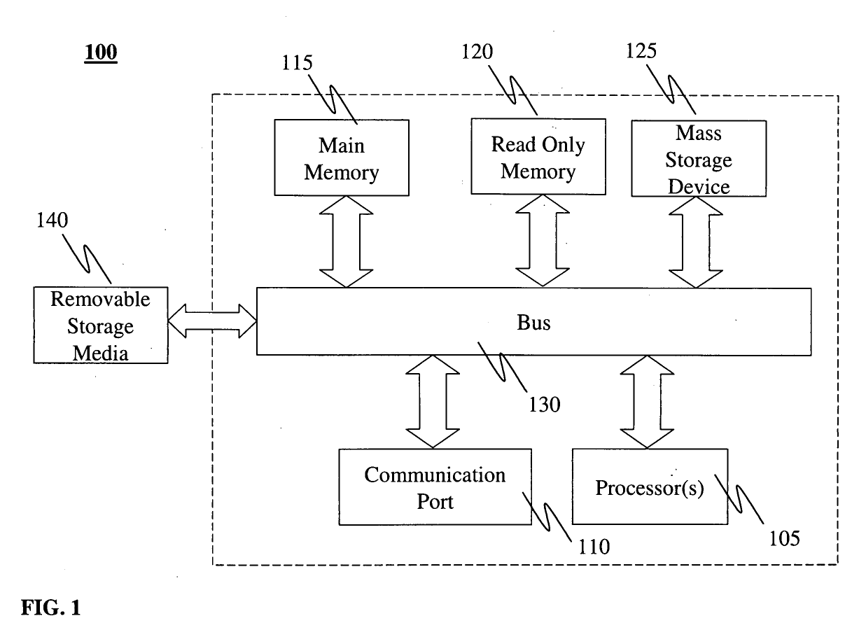

Embodiments of the present invention include various steps, which will be described in more detail below. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 1 is an example of a computer system 100, such as a workstation, personal computer, client or server, upon which or with which embodiments of the present invention may be utilized.

According to the present example, the computer system includes a bus 130, at least one processor 105, at least one communication port 110, a main memory 115, a removable storage media 140 a read only memory 120, and a mass storage 125.

Processor(s) 105 can be any known processor, such as, but not limited to, an Intel® Itanium® or Itanium 2 processor(s), or AMD® Opteron® or Athlon MP® processor(s), or Motorola® lines of processors. Communication port(s) 110 can be any of an RS-232 port for use with a modem based dialup connection, a 10/100 Ethernet port, or a Gigabit port using copper or fiber. Communication port(s) 110 may be chosen depending on a network such a Local Area Network (LAN), Wide Area Network (WAN), or any network to which the computer system 100 connects.

Main memory 115 can be Random Access Memory (RAM), or any other dynamic storage device(s) commonly known in the art. Read only memory 120 can be any static storage device(s) such as Programmable Read Only Memory (PROM) chips for storing static information such as instructions for processor 105.

Mass storage 125 can be used to store information and instructions. For example, hard disks such as the Adaptec® family of SCSI drives, an optical disc, an array of disks such as RAID, such as the Adaptec family of RAID drives, or any other mass storage devices may be used.

Bus 130 communicatively couples processor(s) 105 with the other memory, storage and communication blocks. Bus 130 can be a PCI/PCI-X or SCSI based system bus depending on the storage devices used.

Optionally, operator and administrative interfaces 135, such as a display, keyboard, and a cursor control device, may also be coupled to bus 130 to support direct operator interaction with computer system 100. Other operator and administrative interfaces can be provided through network connections connected through communication ports 110.

Removable storage media 140 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

The components described above are meant to exemplify some types of possibilities. In no way should the aforementioned examples limit the scope of the invention, as they are only exemplary embodiments.

What is claimed is:

1. Apparatus, methods and systems as described herein and in the Appendices of the aforementioned provisional patent application.
